(19) United States
(12) Patent Application Publication
(10) Pub. No.: US 2007/0289970 A1
(43) Pub. Date: Dec. 20, 2007

(54) BICYCLE HEADSET TOP CAP FOR TRACKING DEVICE

(76) Inventor: Josef W. Weichmann, Neenah, WI (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/423,001

(22) Filed: Jun. 8, 2006

(51) Int. Cl. F16L 55/10; B65D 51/00

(52) U.S. Cl. 220/327; 138/89; 220/212

(57) ABSTRACT

The present invention relates to the headset top-cap of the bicycle and more particularly for storage of location transmitters therein. The transmitters within the bicycle headset top-cap will be used to recover stolen bicycles. It can also be used as an asset tracking device. The increased area needed to contain the transmitters and respective components will be accomplished by altering the construction of the top-cap. The components within the top-cap will be accessed through a panel located on the top-cap. The top-cap will be secured to the bicycle by the use of a tamper-proof or locking bolt. An electrical connection within the top-cap will provide the transmitting ability of the device. The top-cap will maintain all rudimentary functions of previous model top-caps.

### INTRODUCTION

The present invention relates to the placement of location transmitters on bicycles

### BACKGROUND OF THE INVENTION

A bicycle compromises a frame, a front fork assembly and handlebars, and front and rear wheels. The front wheel is supported in the fork assembly and is steered by the handlebars which are connected to the fork assembly. The fork assembly has a steerer tube at its upper end which is journaled within a bead tube of the bicycle frame. Bearing arrangements for supporting steering tubes for rotation to allow steering of bicycles aided by the bearing compression provided by a top-cap are generally referred to as bicycle headsets. Bicycle headset top-cap constructions have been provided in the past and have not been entirely satisfactory because of the limited purpose of the component.

Traditional headset top-caps are very limited in functionality. The sole purpose is to provide compression to the bearing race so that proper steering can be achieved for the bicycle.

While many types of property theft have declined in recent years, bicycle theft is on the rise according to FBI and National Bike Registry statistics. The increasing popularity of bicycling as a sport and a means of transportation has made bicycles an easy target for thieves. It is estimated that over 1.5 million bicycles are stolen every year.

The present invention is proposed as a solution to the bicycle theft problem. While bike locks and other securing devices are the normality today, the field of bicycle security through tracking is yet to be explored.

### SUMMARY OF THE INVENTION

One problem encountered when contemplating the incorporating a tracking device on or within a bicycle is where to locate the tracking device. Positioning of the device is crucial to its functionality. When the tracking device is too well hidden in the bicycle, the device has difficulty, or no ability, to transmit data due to interference by rider or other components. On the other hand, if the device is not hidden well enough, it is easily disabled or removed by potential thieves or vandals. The present invention provides a solution to both dilemmas.

Locating the tracking device and its components within the headset top-cap of a bicycle provides both a superb location to transmit data and excellent protection from thieves or vandals.

The headset top-cap is located on the front, and upper portion of a bicycle. Rider and bicycle components have minimal interaction at this point, and the elevated position should generally extend the range of signaling or tracking devices.

In this location, the bicycle stem further protects the tracking device and its components. A bicycle stem completely surrounds the headset top-cap in a thick layer of material, shielding it from removal or attempts to destroy the device.

With the proper locking bolt or device securing the top-cap to the bicycle, there is no way of removing the top-cap. Nothing short of destroying the whole front portion of the bicycle, and its respective components, will remove the top-cap. Without the front portion, the bicycle is rendered completely useless.

Accordingly, it is a principal object of the present invention to provide a new construction of bicycle headset top-caps comprising a top with an aperture; a wall having an outside diameter and an inside diameter forming a cavity attached to the base of the top; a bottom with an aperture attached to the base of the wall and forming an enclosure with the top and wall; a locking bolt for insertion through the top and bottom apertures and securing the top cap to the bicycle; a tracking device inside the top cap; and a battery inside the top cap for powering the tracking device.

Another object of this invention provides a new and improved purpose for the bicycle headset top-cap. In accordance with the last object, the improved purpose of the headset top-cap will be for the storage of a tracking device, transmitter, or other objects.

The object of the said tracking device or transmitter is to track and recover stolen bicycles, or to track the location of bicycle messengers or racers.

Another object is the securing of the said tracking device or other objects within the headset top-cap. In tandem with the aforementioned object, another object is securing the headset top-cap to the host bicycle through the use of special tools, locking bolts, or other devices.

These and other objects, advantages and features of the present invention will become better understood through consideration of the following description in conjunction with the drawings.

### BRIEF DESCRIPTION OF THE DRAWINGS

FIG. 1 shows a schematic perspective view of the traditional headset assembly.

FIG. 2 shows a schematic perspective view of the traditional headset assembly with the present invention in place with locking bolt.

FIG. 3 shows a side view of the traditional headset top-cap construction.

FIG. 4 shows a side view of the present invention headset top-cap construction.

FIG. 5 shows a side view of the present invention headset top-cap in another construction configuration.

FIG. 6 shows a perspective view of a bicycle headset top-cap when part of the assembly; the broken line proportions of the bicycle are shown for illustrative purposes only and form no part of the claimed utility.

FIG. 7 shows a perspective view of a locking bolt.

FIG. 8 shows an underside cutout view of the present invention with tracking components in position.

FIG. 9 shows an underside view of the present invention with access panel.

FIG. 10 shows a cut away side view of the present invention with tracking components present inserted in the bicycle steerer tube.

FIG. 11 shows a cut a way side view of the present invention with tracking components present inserted in the bicycle steerer tube with locking bolt in place.

### DETAILED DESCRIPTION OF THE INVENTION

The present invention provides an improved bicycle headset top-cap that can be used to store, among other things, a transmitting device.

In certain embodiments of the present invention, the headset top-cap has been manufactured to incorporate a deepened structure that occupies an area within the steering tube assembly of the bicycle.

In certain embodiments, the described structure has an enclosed environment where a transmitter or other objects may be stored. The transmitter and its components may share a compartment or they may be separate. The objects can be accessed via an entrance or cover such as, for example, an access panel located on the underside of the top-cap. The access panel will provide the user with easy entrance to the top-cap for any desired reason or purpose.

In certain embodiments of the invention, the access panel can be constructed on a half-moon plate using bolts in a suitable layout. The panel will allow access to the objects that contribute to the function of the transmitter such as the battery, antenna, transmitter, or any other components. Other means or configurations of entrance may also be used.

In order to secure the top-cap to the bicycle, a tamper-resistant bolt or locking device may be used. The techniques for securing the headset will require special tools such as a unique key or removal head to access the top-cap. Other means of securing the headset can also be used.

To recover stolen bicycles, certain embodiments of the invention describe an affixed headset top-cap that may transmit a location. The data transmission may be picked up by a receiving station and then stored so that the bicycle owner can access the location of his property in real-time at any point through a website access, cell phone, PDA, computer, or other suitable devices. Other means of tracking methods or devices may also be used.

The present invention is intended to be a direct replacement for the prior model headset top-cap. Meaning that, extensive modifications should not be required to retrofit the described device to the bicycle. With few modifications necessary to equip a bicycle with the device, the present invention may be applied easily as an aftermarket replacement or can be direct installed in the bicycle during production by the manufacturer.

The present invention maintains all of the rudimentary functions of previous model headset top-caps. That is, providing compression to the bearing race component of the headset so that proper steering can be achieved.

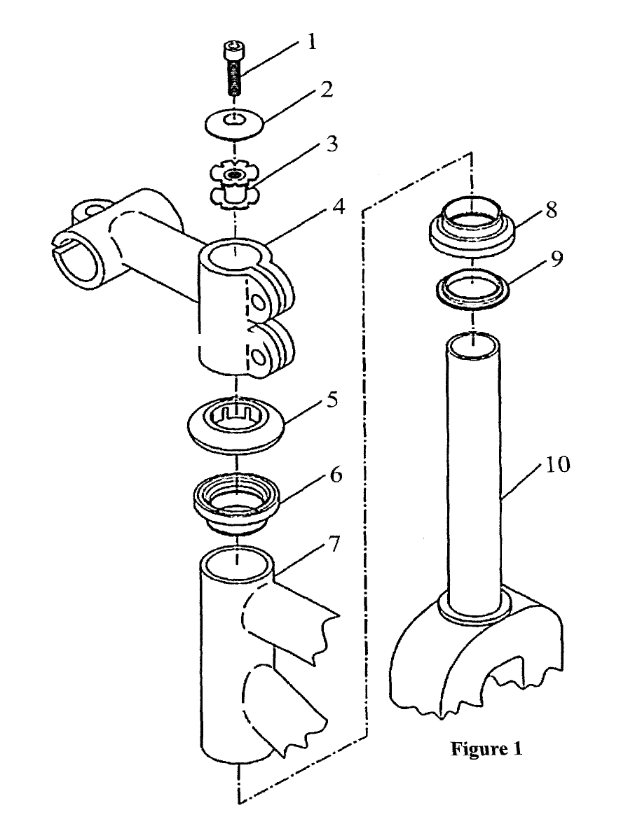

FIG. 1 provides a schematic representation of the traditional headset assembly. In order to establish the rudimentary purpose of the headset top cap, the following order of progression in the headset will be described: The bolt 1, inserts into the top-cap 2, then top-cap 2 is inserted into stem 4 and steerer tube 10. The bolt 1, which is inserted through top-cap 2, threads into the star nut 3 (which is punched into the steerer tube 10 of the bicycle fork).

Components 1, 2, 3, 4 are used to the compress the bearing race modules that follow below. Without sufficient compression, proper steering cannot be achieved on the bicycle. In order to complete the headset assembly, the upper bearing cup 6 and lower bearing cup 8 are pressed into the bicycle head tube 7. From there, the top race 5 is set onto the upper bearing cup 6 and the crown race 9 is pressed onto the steerer tube 10. Compression of the bearing race is achieved when the star nut 3, located in the steerer tube 10, is secured to the top-cap 2, by the bolt 1.

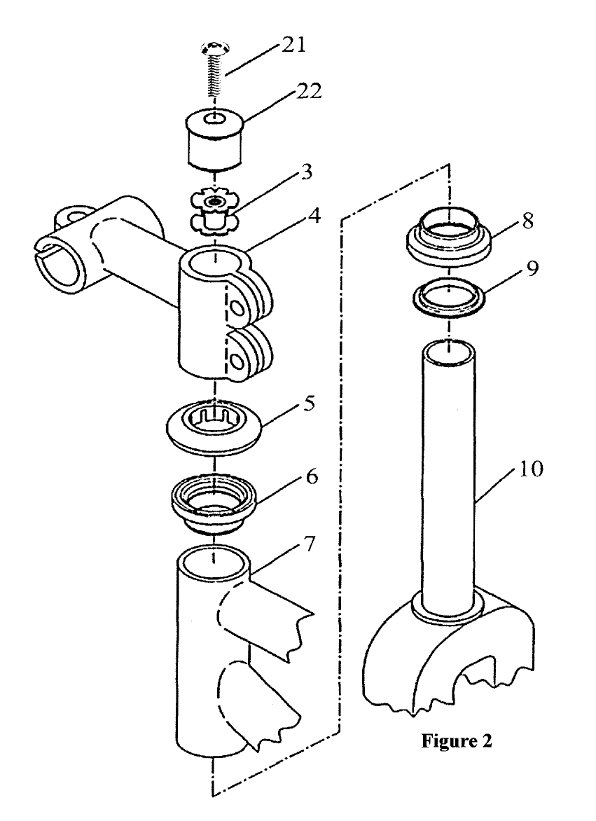

FIG. 2 is an identical schematic perspective view of the traditional headset assembly with the top-cap 22. The top-cap 22 follows the same order of installation and holds the same functional standpoint as the traditional top-cap 2. That is providing compression to the bearing race components of the headset.

However, the present invention is represented with an elongated or resized construction for storage purposes of a tracking device or other objects. The headset top-cap is aided in compression by a tamper-proof bolt 21 or locking device such as keys or combination dials.

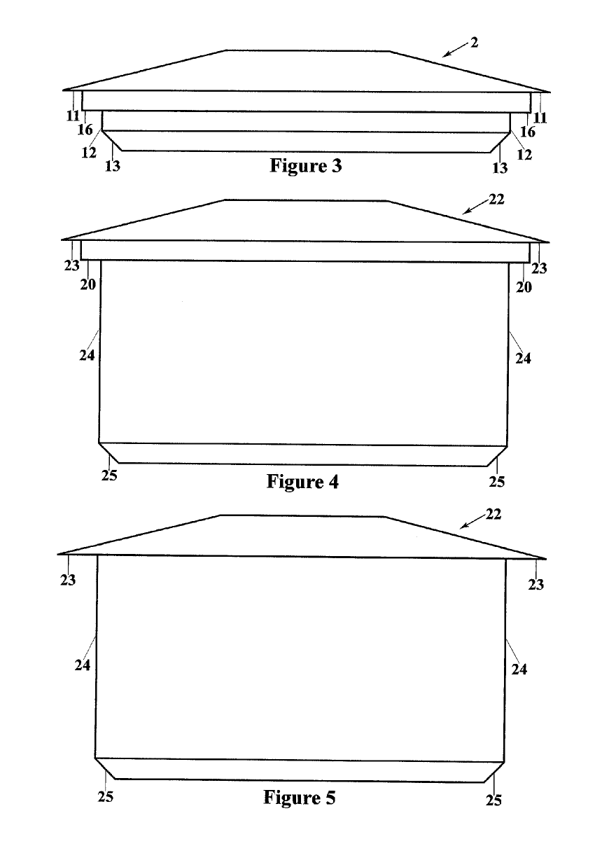

FIG. 3 represents a side-view of the traditional headset top-cap 2. The outer flange 11 of the top-cap 2 sits atop the upper cylindrical wall of the bicycle stem 4. The inner flange 16 of the top cap 2 sits atop the cylindrical wall of the steerer tube 10. The cylindrical outer wall 12 of the top-cap 2 sits within the cylindrical wall of the steerer tube 10. The taper 13 of top-cap 2 provides ease of installation into steerer tube 10.

FIG. 4 is a side view top-cap 22. The outer flange 23 of the top-cap 22 sits atop the upper cylindrical wall of the bicycle stem 4. The inner flange 20 of the top cap 22 sits atop the cylindrical wall of the steerer tube 10. The cylindrical outer wall 24 of the top-cap 22 sits deep within the cylindrical wall of the steerer tube 10. The taper 25 of top-cap 22 provides ease of installation into steerer tube 10. This view is intended to show the size of depth in the traditional headset top-cap construction.

FIG. 5 is another side view of top-cap 22. In this figure there is no inner flange 20, because this particular flange is not necessary in the construction. However, it is recommended that flange 20 exist in the interest of structural integrity for top-cap 22. The top-cap 22 shown in this figure will fit and function identical to the top-cap 22 in FIG. 4. This view is also intended to show the depth in the present invention headset top-cap as well as the differing construction. The new depth or construction or any combination of the two will allow for the storage of single or multiple objects of suitable configuration and type.

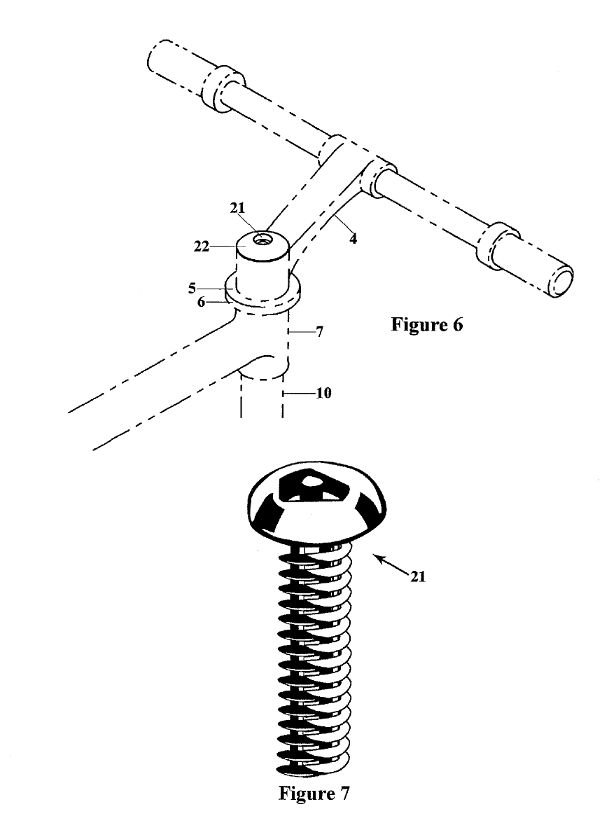

FIG. 6 is a perspective view of a bicycle headset with top cap 22 and locking bolt 21 present when fully assembled on a bicycle. This view is intended to show the location of the headset and top-cap 22 of a bicycle on a larger scale.

FIG. 7 is a view of the tamper-proof bolt 21. The bolt 21 uses special tools to secure the top-cap 22 to the bicycle. The said special tools are variations of custom made heads to remove the bolt. Without the special tool, the bolt cannot be removed. Screwdrivers, hex keys, allen keys, or any other tool cannot be used to remove the bolt.

The head of the bolt 21 is what makes it tamper-proof. The inner removal surface where the special tool will be inserted is unique to the owner. The centermost portion of the head will also contain a raised section of material to prevent the use of the aforementioned tools.

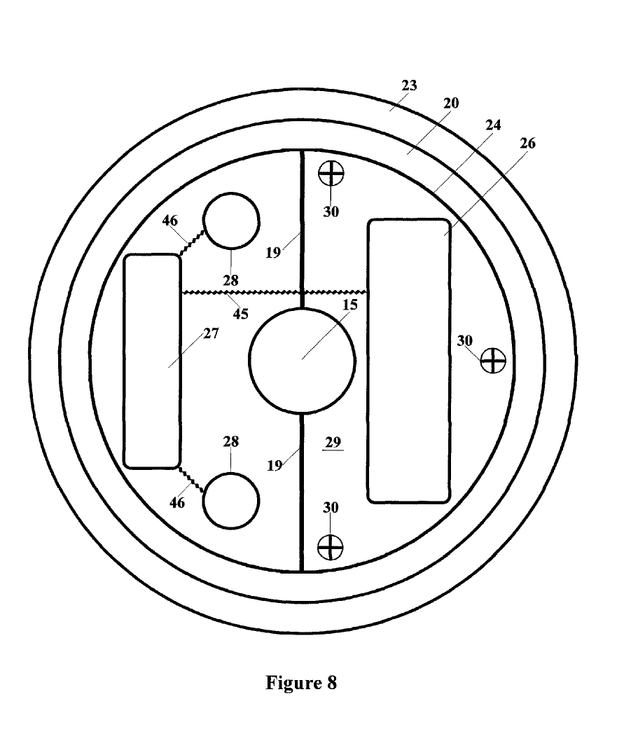

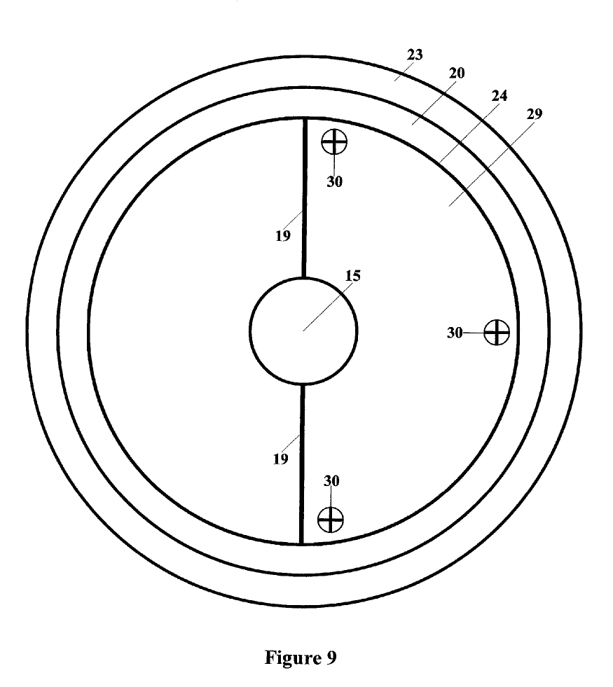

FIG. 8 is an underside cut-out view of the top-cap 22 with tracking components present. It shows the outer flange 23, inner flange 20, and cylindrical outer wall 24 of the top-cap 22 for reference purposes. A transmitter or tracking device 27 and antennas 28 are shown in the left hemisphere of the top-cap 22. The aforementioned components are separated by divider 19. The separated compartment is completely sealed off from the rest of the top-cap 22 insides.

The right hemisphere of the top-cap 22 contains the battery 26. The battery 26 is changed or removed via an access panel 29 (see FIG. 8). The access panel is attached to the device by screws 30 arranged in a triangular fashion, thus securing each corner of the access panel 29.

The aperture 15 is where the bolt 21 will be inserted when it is threaded into star nut 3. An electrical connection 45 runs from the battery 26 to the transmitter or tracking device 27. From the transmitter or tracking device 27, the electrical connection 46 then runs to the antennas.

The purpose of the access panel 29 is to provide access to the battery compartment of the top-cap 22. By removing the aforementioned bolts 30, the compartment will become accessible and the battery 26 may be altered or removed.

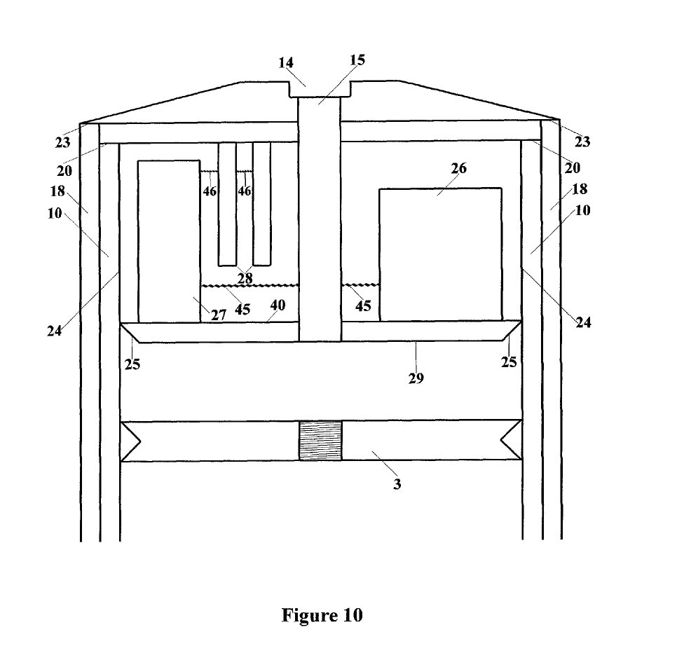

FIG. 10 shows a cut a way side view of top-cap 22 with tracking components present. The tracking device 27 and antennas 28 are separated from the battery 26 by the diving wall 19 (shown in FIG. 8).

The tracking device 27, located in the left hemisphere, is placed on the bottom 40 of the enclosed top-cap 22 and electrically connected to the battery 26 by wire 45. The antennas 28 are located in the upper most portion of the top-cap 22. When in the upper portion of the top-cap, the antennas 28 will have the best ability to transmit and receive data with little or no interference.

The battery 26, located in the right hemisphere, is placed on the bottom 40 of the top-cap 22 where it can be easily accessed via the panel 29.

The bolt head recess 14 is located in the center of the top-cap 22. The bolt aperture 15 is coaxial with recess 14; and, it spans the entire length of the top-cap 22.

The star nut 3 is shown to reference the location of the bolt aperture 15 to where the locking bolt 21 will insert and thread.

Outer flange 23 is shown to reference the point where the top-cap 22 rests on the upper cylindrical wall 18 of the stem 4.

Inner flange 20 is shown to reference the point where the top-cap 22 rests or floats on the cylindrical wall of the steerer tube 10. Whether the inner flange 20 rests or floats on the cylindrical wall of the steerer tube 10 depends on the original length of the steerer tube 10 from the bicycle manufacturer. Long or short, the length of the steerer tube 10 has no affected on the present invention 22.

The outer cylindrical wall 24 of top-cap 22 sits deep within the walls of the steerer tube 10. The taper 25 is for ease of installation.

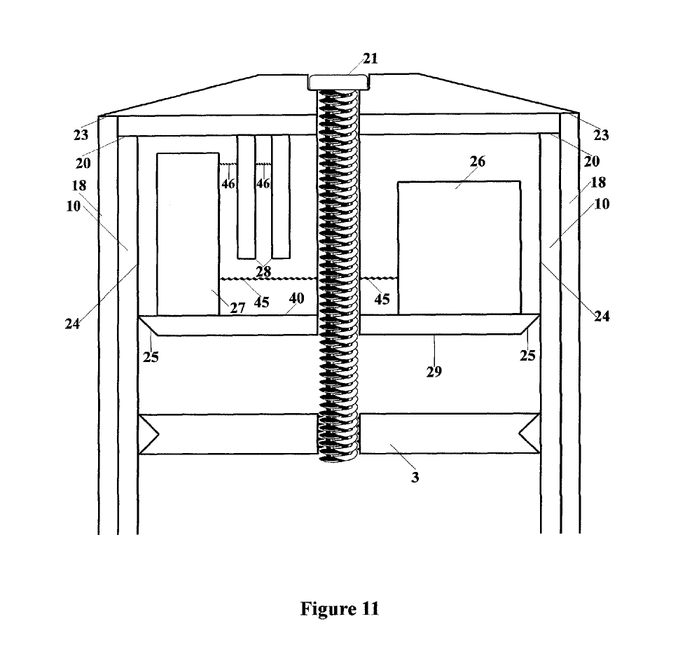

FIG. 11 shows a cut a way side view of the present invention with tracking components present inserted in the bicycle steerer tube with locking bolt in place. The locking bolt 21 inserts through the center of top-cap 22, through bolt aperture 15, and threads into star nut 3.

When top-cap 22 is secured to the bicycle through the combination of bolt 21 and star nut 3, the bearing race component of the headset is properly compressed. Through sufficient compression, steering of the bicycle can be attained.

Visible in FIGS. 10 and 11, the top-cap 22 and the battery 26, transmitter or tracking device 27, and antennas 28 are safely secured within the cylindrical walls of the steerer tube 10 and upper cylindrical walls 18 of the stem 4.

Transmitters and tracking devices using GPS or other technologies are well know in the art and are not detailed herein as any tracking device or locator transmitter may be used in conjunction with the invention. As within the aforementioned statement, the respective components associated with the tracking device may be located within the top-cap or at any other location on the bicycle outside of the top-cap.

Although the access panel 29 is shown at the bottom of the top cap it can be on the side. The split compartment on the inside may be one compartment or segmented into more than two compartments.

While specific embodiments of the present invention have been shown and described, various modifications may be made without departing from the scope of the present invention, and all such modifications and equivalents are intended to be covered.

What is claimed is:

1. A headset top cap for tracking bicycles, comprising: a top with an aperture;
a wall having an outside diameter and an inside diameter forming a cavity attached to the base of the top;
a bottom with an aperture attached to the base of the wall and forming an enclosure with the top and wall;
a locking bolt for insertion through the top and bottom apertures and securing the top cap to the bicycle;
a tracking device inside the top cap; and
a battery inside the top cap for powering the tracking device.

2. A headset top cap according to claim 1 wherein said bottom has an access panel which can be removed to access the inside of said top cap.

3. A headset top cap according to claim 2 wherein said access panel is secured to the bottom of the top cap by screws or any other mechanical means such as latches, cam-and-grove, lockable quick release couplings.

4. A headset top cap according to claim 1 wherein a divider extending between the walls and from the top to the bottom divides the top cap into compartments.

5. A headset top cap according to claim 1 wherein an internal tube extending from said top aperture to said bottom aperture acts as a guide for said locking bolt.

6. A headset top cap according to claim 1 wherein a recess in the top coaxial with the aperture allows for recessing a head on said locking bolt.

7. A headset top cap according to claim 1 containing a flange on said top cap, said flange having an outer diameter greater than the outer diameter of said wall such that the top cap can rest on the top of a stem on the bicycle.

8. A headset top cap according to claim 1 wherein a chamfer on the bottom of said wall allows the top cap to be inserted into the stem with greater ease.

9. A headset according to claim 4 wherein an internal tube extending from said top aperture to said bottom aperture acts as a guide for said locking bolt.

10. A headset according to claim 4 wherein a recess in the top coaxial with the aperture allows for recessing a head on said locking bolt.

11. A headset according to claim 9 wherein a recess in the top coaxial with the aperture allows for recessing a head on the locking bolt.

12. A headset top cap according to claim 4 incorporating a flange on said top cap, said flange having an outer diameter greater than the outer diameter of the wall such that the top cap can rest on the top of a stem on the bicycle.
